(19) United States
(12) Patent Application Publication
(10) Pub. No.: US 2024/0208742 A1
(43) Pub. Date: Jun. 27, 2024

(54) SORTING CONVEYOR, IN PARTICULAR CROSS-BELT SORTER OR TILT-TRAY SORTER, FOR TRANSPORTING AND SORTING GOODS, COMPENSATING ELEMENT, AND METHOD OF OPERATING A SORTING CONVEYOR

(71) Applicants: MK Klassik GmbH, Haar (DE); Coop Systems GmbH, Waakirchen (DE)

(72) Inventor: Manfred Köstlmeier, Haar (DE)

(21) Appl. No.: 18/392,087

(22) Filed: Dec. 21, 2023

(30) Foreign Application Priority Data
Dec. 21, 2022 (DE) 10 2022 134 280.8

(51) Int. Cl. B65G 47/28

(52) U.S. Cl. CPC B65G 47/28

(57) ABSTRACT

A sorting conveyor for transporting and sorting goods has a plurality of conveyor carriers which are moved on a conveyor track, are coupled to a conveyor carrier train or are moved individually and on which the goods can be transported in a resting manner, with a gap being formed between two directly successive conveyor carriers of the conveyor carrier train. A compensating element closes the gap between the two directly consecutive conveyor carriers, at least in certain areas with respect to the longitudinal direction of the gap and/or the transverse direction of the gap. The compensating element performs compensating movements between a rear edge zone of a rear edge of the front conveyor carrier in the direction of travel and an associated front edge zone of a front edge of the rear conveyor carrier in the direction of travel in the event of distance changes, to keep the gap closed.

### CROSS-REFERENCE TO RELATED APPLICATION

This application claims the priority, under 35 U.S.C. § 119, of German Patent Application DE 10 2022 134 280.8, filed Dec. 21, 2022; the prior application is herewith incorporated by reference in its entirety.

### FIELD AND BACKGROUND OF THE INVENTION

The invention relates to a sorting conveyor, in particular a cross-belt sorter or a tilt-tray sorter, for transporting and sorting goods according to the preamble of the independent sorting conveyor claim. In addition, the invention relates to a compensating element for use with a conveyor carrier of a sorting conveyor according to the preamble of the compensating element claim and to a method for operating a sorting conveyor according to the preamble of the independent method claim.

Sorting conveyors, also known as distribution conveyors, are goods sorting systems for identifying goods arriving in an unordered sequence on the basis of predetermined distinguishing features and for distributing them to destinations that are defined according to the respective requirements (see VDI guideline 3619). The usual basic structure of sorting conveyors includes a sorting section 100 as shown in FIG. 1, with loading points (not shown) and unloading points 200 arranged in sequence along this sorting section 100. Conveyor carriers 300, also referred to as carriers, are guided and driven in succession along the sorting line 100. As shown in FIG. 1, which illustrates the prior art, the sorting conveyor thus contains a plurality of conveyor carriers 300, which are moved on a conveyor track and are coupled to a conveyor carrier train or can be moved individually, on which the goods can be transported in a resting manner. As can also be seen from FIG. 1, which shows the state of the art, a gap distance or gap 500 is formed between two directly successive conveyor carriers 300, in particular between a rear edge of a front conveyor carrier 300 in the direction of travel and a front edge of a rear conveyor carrier in the direction of travel of the conveyor carrier train. In the present example shown in FIG. 1, the sorting conveyor is configured as a cross-belt sorter, in which the conveyor carriers 300 are each provided with a transverse belt 400 which circulates endlessly around deflection rollers and can be driven transversely to the direction of travel of the conveyor carriers 300, in order to be able to discharge the goods transported on the transverse belt 400 in a resting manner (not shown), for example at the unloading points shown here.

Due to the high speed of such sorting conveyors, with which throughputs of more than 10,000 sorted or unit loads per hour are achieved, there is a risk that the transported good can get into the area of the gap 500 between two immediately consecutive conveyor carriers 300, which in turn entails the risk that the good then arranges itself between the two conveyor carriers and becomes jammed in such a way that the conveyor carriers derail and are thrown out of the conveyor track. This leads to considerable disruptions in the operation of such sorting conveyors.

The same problem basically exists with sorting conveyors that are designed as tilt-tray sorters and in which tiltable trays are attached to the individual conveyor carriers, which have the task of receiving the good to be transported. The tilting trays are aligned horizontally in their basic position and are only tilted when they reach the intended end point in order to unload or discharge the goods.

### SUMMARY OF THE INVENTION

The object of the invention is to provide a sorting conveyor, in particular a cross-belt sorter or tilt-tray sorter as a sorting conveyor, for transporting and sorting goods, by means of which impairments to the operation of a conveyor carrier train, which consists of a plurality of conveyor carriers moving on a conveyor track, can be reliably reduced in a simple and functionally reliable manner. A further object of the invention is to provide a method for operating such a sorting conveyor as well as a compensating element for a sorting conveyor.

This problem is solved with the features of the independent patent claims. Advantageous embodiments are the subject of the referenced subclaims.

Accordingly, a sorting conveyor, in particular a cross-belt sorter or tilt-tray sorter, is proposed for transporting and sorting goods, which has a plurality of conveyor carriers which are moved on a conveyor track, are coupled to a conveyor carrier train or can be moved individually, on which the good can be transported in a resting manner, preferably in order to load the good transported in a resting manner at defined loading points and/or to unload it at defined unloading points. A gap distance or gap is formed between two immediately successive conveyor carriers of the conveyor carrier train, in particular between a rear edge of a front conveyor carrier in the direction of travel and a front edge of a rear conveyor carrier of the conveyor carrier train in the direction of travel.

According to the invention, at least one compensating element is provided, which closes the gap between the two immediately successive conveyor carriers, with respect to the longitudinal direction of the gap and/or the transverse direction of the gap, at least in certain regions, and which is suitable and configured to perform compensating movements in the event of travel-related relative distance changes between a rear edge zone of a rear edge of the front conveyor carrier in the direction of travel and an associated front edge zone of a front edge of the rear conveyor carrier in the direction of travel, in order to keep the gap substantially closed.

This is a simple and reliable way of preventing a good being transported by the conveyor carriers from entering or falling into the gap between two immediately consecutive conveyor carriers, which in turn significantly reduces or prevents the risk of the conveyor carriers derailing or being thrown out of the conveyor track.

In order to achieve this objective in a particularly advantageous and functionally reliable manner, according to a particularly preferred embodiment, it is provided that the at least one compensating element predominantly or substantially completely closes the gap between two immediately successive conveyor carriers, with respect to the longitudinal direction of the gap and/or the transverse direction of the gap. Alternatively or additionally, it has also proven to be particularly advantageous in this context if the at least one compensating element is arranged in an upper region of the conveyor carriers with respect to the vertical axis direction, in particular if it is arranged essentially flush with the upper surfaces of the two conveyor carriers.

The at least one compensating element can in principle be formed in different ways, in particular using different materials and shapes. However, it is particularly preferred that the at least one compensating element is suitable and designed to keep the gap substantially closed by expanding the compensating element when the distance increases and by contracting the compensating element when the distance decreases. This expansion and contraction of the compensating element is an advantageous way of ensuring that the compensating element itself essentially only ever bridges the gap or gap distance, but without running the risk of reaching the area of the conveyor carriers' rollers, for example, and possibly causing the conveyor carriers to derail. This is achieved, for example, by the compensating element being formed by an at least partially elastic element which, in order to carry out the compensating movements between the rear edge zone of the front conveyor carrier in the direction of travel and the associated front edge zone of the rear conveyor carrier in the direction of travel, expands elastically when the distance increases and contracts elastically when the distance decreases.

Furthermore, as the inventor's experiments have shown, this is achieved alternatively or additionally to a particularly advantageous extent by the fact that the at least one compensating element is formed by a folding cover, preferably by a lamella folding cover folded in an accordion-like or zigzag-like manner with a plurality of lamellas, which unfolds to perform the compensating movements between the rear edge zone of the front conveyor carrier in the direction of travel and the associated front edge zone of the rear conveyor carrier in the direction of travel when the distance increases and folds up when the distance decreases. Such a folding cover can not only be manufactured in a particularly simple way, but is also characterized by a long service life and high functional reliability, which is ideally suited for rough operation in conjunction with a sorting conveyor. Such a folding cover can also be manufactured in different ways, for example with and without elastic areas, so that there is also a high degree of flexibility in the manufacture and design of the folding cover, which can be easily adapted to different sorting conveyor systems.

According to a further particularly preferred specific embodiment, at least one mounting device is provided, by means of which the at least one compensating element is attached directly or indirectly to the rear edge of the front conveyor carrier in the direction of travel and directly or indirectly to the front edge of the rear conveyor carrier in the direction of travel. This attachment is preferably detachable. With the aid of such a mounting device, it is possible to arrange the at least one compensating element in the desired manner in the area of the gap in a simple and reliable manner.

According to a further particularly preferred specific embodiment, it may be provided that the at least one mounting device has a folding cover holding device, in particular a folding cover cassette receiving at least a partial area of the folding cover as a folding cover holding device, by means of which the folding cover, in relation to the vertical axis direction, can be supported from above and/or below and/or by means of which the folding cover is fixable, preferably releasably fixable, preferably directly or indirectly to one of the two conveyor carriers, preferably directly or indirectly to the rear edge of the front conveyor carrier in the direction of travel or to the front edge of the rear conveyor carrier in the direction of travel, in the gap, preferably in a precisely and positionally accurate manner. According to this specific embodiment, the folding cover holding device thus ensures that the folding cover is arranged in the area of the gap in a functionally safe and reliable manner, whereby the arrangement is made on one of the two conveyor carriers forming the gap between them. This conveyor carrier therefore serves in a preferred dual function not only for transporting the goods, but also as an aid for positioning and fixing the folding cover in the area of the gap.

In a specific embodiment in this respect, it may be provided that the folding cover holding device, in particular a folding cover cassette, has a lower support element, relative to the vertical axis direction, which extends below the folding cover, preferably extends below the folding cover and supports the folding cover in a resting manner, and/or which covers and/or supports the folding cover on its underside over more than half of its longitudinal extension direction. This allows the folding cover to be supported over a large area, whereby the support element can in principle be designed in a wide variety of ways. A particularly preferred embodiment is one in which the lower support element is formed by a lower support plate in a simple manufacturing process.

Furthermore, the lower support element in the basic state, i.e. with the front edge and rear edge of two successive conveyor carriers aligned parallel to one another, can be arranged on a first of the two conveyor carriers in such a way that a front support element edge facing the second conveyor carrier has a gap distance to the second conveyor carrier and/or is aligned essentially parallel to the correspondingly assigned front edge or rear edge of the second conveyor carrier. Such a gap distance between the support element edge and the second front edge has the effect that the two conveyor carriers cannot collide with each other when the conveyor carrier train travels uphill or cannot collide with each other in a way that interferes with driving. Accordingly, the gap distance must be selected so large that it can be reduced, depending on the uphill travel to be completed in the specific case, to such an extent that there is no or at most only a minimal impact of the stop element edge on the second conveyor carrier that is not critical for the operation of the conveyor carrier train.

In principle, there are different ways to implement this.

Thus, according to a first specific embodiment, it can be provided that the lower support element in the basic state with the front edge and rear edge of two successive conveyor carriers aligned parallel to one another is arranged on the front edge of the rear conveyor carrier in the direction of travel in such a way that a front support element edge facing the rear edge of the front conveyor carrier in the direction of travel has a gap distance to a rear edge of the front conveyor carrier in the direction of travel and/or is aligned parallel to the rear edge of the front conveyor carrier in the direction of travel. Correspondingly vice versa, namely in the sense of a kinematic reversal, it can be provided that the lower support element in the basic state, with the front edge and rear edge of two successive conveyor carriers aligned parallel to one another, is arranged at the rear edge of the front conveyor carrier in the direction of travel in such a way that a front support element edge facing the front edge of the rear conveyor carrier in the direction of travel has a gap distance to the front edge of the rear conveyor carrier in the direction of travel and/or is aligned parallel to the front edge of the rear conveyor carrier in the direction of travel.

According to a further particularly preferred specific embodiment, it can be provided that the front support element edge, viewed in the longitudinal direction of the gap, has a tapering on both sides, preferably a straight or stepped tapering, which, starting from the front support element edge, slopes away from the front support element edge towards the rear. These tapering elements serve or are suitable and designed to enable a greater angular deflection between the two successive conveyor carriers during cornering compared to an imaginary continuously straight front support element edge and/or to form a stop for the conveyor carrier traveling in front of or behind. In short, the taperings are used to determine and define the bending angle between two successive conveyor carriers. This is particularly advantageous because the bending angle between the two conveyor carriers has an influence on the compensating movements to be carried out in the gap with the at least one compensating element. These compensating movements can thus be safely controlled.

In a particularly preferred design, the lower support element is arranged approximately in a central area of the gap in relation to the gap length in the longitudinal direction of the gap and/or extends over more than half of the gap length in the longitudinal direction of the gap. This results in a particularly advantageous support of the respective compensating element, which has a beneficial effect on the functional reliability of the entire arrangement.

According to a further particularly preferred specific embodiment, it may be provided that the folding cover holding device, in particular a folding cover cassette as a folding cover holding device, has an upper support element, preferably an upper support plate, with respect to the vertical axis direction, which extends above the folding cover and/or covers the folding cover on its upper side, preferably in a central folding cover area with respect to the longitudinal direction of the folding cover. Such an upper cover element can thus form an advantageous lift-off protection for a folding cover as a compensating element. This is achieved with a particularly preferred embodiment in which the upper cover element extends above the folding cover and/or covers the folding cover on its upper side, so that the support element side edges of the upper support element opposite in the longitudinal direction of the gap form an abutment element for the folding cover areas projecting beyond the upper support element on both sides in the longitudinal direction of the gap and thus block the folding cover or the two projecting folding cover areas from lifting off in the vertical axis direction completely or after a defined displacement path.

In principle, a structure is possible in which only an upper support element or only a lower support element is provided. However, especially for the provision of a particularly preferred cassette solution, it is advantageous if the folding cover holding device has an upper support element and a lower support element. In this case, the folding cover can then be accommodated at least in part between the lower support element and the upper support element, which results in a particularly functionally reliable positioning and arrangement of the folding cover.

In particular for forming a folding cover cassette, it is advantageous if the lower support element and the upper support element are connected to one another by means of at least one connecting web, preferably aligned in the vertical axis direction, whereby it is preferable that the lower support element and the upper support element are each connected by means of at least one connecting web at their opposite end regions in the direction of travel, i.e. there are at least two connecting webs in total.

According to a further particularly preferred embodiment, at least one fixing element, preferably at least one fixing pin or fixing bolt as a fixing element, is provided, which penetrates the lamellas as seen in the direction of travel or transverse direction and/or which is held on at least one connecting web, preferably on connecting webs opposite in the direction of travel. This enables simple, functionally safe and reliable fixing of the folding cover to the folding cover holding device designed as a folding cover cassette.

According to a further particularly preferred specific embodiment, the mounting device has at least one first fastening device, by means of which the folding cover holding device, in particular a folding cover cassette, can be fixed to a first of the two conveyor carriers. In this context, according to a particularly preferred optional embodiment, it is provided that at least one of the connecting webs of the folding cover holding device has or forms the fastening device. This results in a particularly advantageous dual function of the at least one connecting web, which leads to an advantageous component reduction.

Furthermore, the mounting device has at least one further fastening device by means of which the folding cover itself, preferably an end-side lamella of the folding cover facing the second conveyor carrier, can be fixed, preferably releasably fixed, to the second conveyor carrier. With such a specific design of the fastening devices, a simple and functionally reliable arrangement or attachment of the folding cover to the two conveyor carriers in the area of the gap distance or gap to be bridged is thus possible. For this purpose, a particularly preferred assembly sequence can be provided in which the folding cover holding device, in particular a folding cover cassette as a folding cover holding device, is first fixed to a first conveyor carrier, so that the folding cover is then already held in the correct position and position. Subsequently, only the folding cover itself needs to be fixed to the second conveyor carrier, for example by pulling a lamella at the end towards the second conveyor carrier and hooking it in there, as described in more detail below. The detachable attachment of the folding cover to the second conveyor carrier ensures that the gap area can be easily separated and released, for example during disassembly.

According to a specific embodiment in this respect, the at least one first fastening device can be formed by at least one fastening ledge, which can be fixed to the first conveyor carrier by means of a plurality of screw connections spaced apart in the longitudinal direction of the gap.

This type of fastening ledge, in conjunction with the screw connections spaced in the longitudinal direction of the gap, ensures a functionally reliable and easy-to-produce fastening that can also be easily removed again if required.

Furthermore, the at least one additional fastening device is preferably configured as a coupling connection to which the folding cover, in particular an end-side lamella of the folding cover, can be attached. Such a coupling connection is particularly easy to manufacture and also has a high level of functional reliability. In this context, an embodiment is advantageous in which the coupling connection is formed by a plurality of suspension pins which are spaced apart from one another in the longitudinal direction of the gap or folding cover and/or are assigned to opposite folding cover end regions and which project from the second conveyor carrier, it being preferred that these project upwards in the vertical axis direction so that the suspension can advantageously take place from above. In principle, however, it is also possible for the suspension pins to project downwards, so that the folding cover is then hooked in from below, as viewed in the vertical axis direction. Alternatively or additionally, it is particularly advantageous if these suspension pins are suitable and designed so that the end-side lamella can slide along them, especially when cornering, without being released. In contrast to a fixed connection, which is also possible in principle, this reduces the load acting on the folding cover or the end-side lamella and thus increases the service life of the folding cover.

The folding cover itself is preferably formed by a sheet of material folded in an accordion or zigzag manner, whereby it is preferable that the individual folding sections form lamellas running in the longitudinal direction of the folding cover, which alternately have upper connecting zones and lower connecting zones. Such a fold, also known as a Leporello fold, is characterized by a very robust design that is easy to manufacture and ensures high functional reliability over a very long service life. Such an accordion-like or zigzag folded sheet of material is therefore easy to produce and is a particularly simple way of creating the desired compensating movements between two directly consecutive conveyor carriers. The fact that the lamellas have upper and lower connecting zones does not mean that the lamellas are separate components to be connected to each other, although this can of course also be the case. The connection between two lamellas can, of course, also be formed in a single material and in one piece. In this respect, the terms upper and lower connecting zones merely serve to indicate a change or transition from one lamella to the next.

According to a further particularly preferred embodiment, it is provided that the folding cover has at least one stiffening element stiffening the folding cover, wherein it is preferred that the at least one stiffening element is configured in the

form of a strip and/or rod and extends in the longitudinal direction of the folding cover along at least one associated lamella or between two lamellas. With such a stiffening element, a desired weight design of the folding cover, which must regularly be able to support unit loads weighing up to 20 kg, preferably unit loads weighing up to 30 kg, sometimes even unit loads weighing up to 50 kg and even more without damaging and/or without bending the folding cover in a resting manner, can be achieved in a simple and functionally reliable manner.

Particularly preferred here is also a specific embodiment in which the folding cover, preferably in an area below at least one upper connecting zone, preferably in an area below all upper connecting zones, as viewed in the vertical axis direction, has a pocket, preferably a pocket aligned in the vertical axis direction, in which at least one strip-like and/or rod-like stiffening element is accommodated, the pocket and/or the stiffening element extending at least over a partial area of the length, preferably over essentially the entire length, of the folding cover. Such a design contributes significantly to stabilizing and stiffening the folding cover as a whole.

The sheet of material itself can be formed in different ways. However, it is particularly preferred that the sheet of material is formed by a fabric coated on both sides, preferably with a water-repellent or waterproof material, whereby it is preferable that the coating material is a thermoplastic polyurethane. This ensures that in the event of any liquid leaks, no liquid can run through the gap and possibly cause damage to the sorting conveyor or along the route.

The pocket itself is preferably formed by a fabric coated only on the outside of the pocket and thus on one side, preferably with a water-repellent or waterproof material, with the coating material preferably being a thermoplastic polyurethane. In addition, it is provided that the pocket is welded in at least one defined connection area with its coated outer side to at least one coated lamella, preferably welded by high-frequency welding. The one-sided coating of the pocket on its outer side facing the lamellas ensures that the inner walls of the pocket cannot stick together during welding.

According to a particularly preferred embodiment, the pocket is U-shaped and the free U-leg ends of the pocket are welded with their coated outer sides to correspondingly assigned, directly adjacent coated lamellas, preferably welded at or near an upper connecting zone of the folding cover.

Alternatively or additionally, the stiffening element can be made of any suitable material, although it is preferable to manufacture it from a stable plastic, wood, iron, sheet metal or aluminum. Such materials are materials that reliably prevent the stiffening elements from buckling under load.

It can also be provided that a pivot pin aligned in the vertical axis direction is arranged in a space between two directly adjacent lamellas of the folding cover. This at least one pivot pin is preferably held on the folding cover holding device, most preferably on the upper and lower support element. Furthermore, it may optionally be provided in this context that the pivot pin penetrates a connecting zone of the folding cover, preferably a lower connecting zone of the folding cover. Alternatively or additionally, the pivot pin should be suitable and configured to hold an associated stiffening element in its position, in particular to secure it against twisting and/or tilting, and/or to form a pivot bearing about which the respectively associated lamellas and/or stiffening elements can be pivoted in the horizontal plane of the folding cover, preferably within predetermined limits. This ensures that when one side of the folding cover is unfolded, the other side of the folding cover, which is opposite in the longitudinal direction of the folding cover, is folded up in a functionally reliable manner.

As already mentioned at the beginning, the conveyor carriers can be configured in different ways, for example as cross-belt sorters or tilt-tray sorters. However, cross-belt sorters are preferably used for high throughputs with several tens of thousands of sorted goods or unit loads per hour. In this context, it is particularly advantageous if the conveyor carriers are each provided with a transverse belt that circulates endlessly around deflection rollers and can be driven transversely to the direction of travel of the conveyor carriers to form a cross-belt sorter. Furthermore, it is particularly advantageous in this context if, viewed in the vertical axis direction, a cover, preferably a cover plate, is provided above the compensating element, which only partially covers the gap and the compensating element, is attached to a first of the two successive conveyor carriers and, in the basic position, with the front edge and rear edge of the two successive conveyor carriers aligned parallel to one another, engages or is guided under the cross belt of the second conveyor carrier with a cover plate projection. Such a cover or cover plate serves to functionally safe and reliably cover any remaining gap remnants of the gap that are not covered by the compensating element, such as those that can occur when cornering, and thus further increases the safety that the goods cannot fall into the gap between two conveyor carriers.

The invention also relates to a compensating element for use with conveyor carriers of a sorting conveyor. Furthermore, the invention also relates to a method for operating a sorting conveyor. The advantages that can be achieved in each case are identical to those of the sorting conveyor described in detail above. In this respect, reference is made to the explanations given above in order to avoid repetition.

Other features which are considered as characteristic for the invention are set forth in the appended claims.

Although the invention is illustrated and described herein as embodied in a sorting conveyor, in particular a cross-belt sorter or a tilt-tray sorter, for transporting and sorting goods, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a structure of a sorting conveyor according to the prior art;

FIG. 2A a schematic top view of three conveyor carriers of the sorting conveyor with gap distance or gap between the conveyor carriers (without folding cover);

FIG. 2B is a top view as in FIG. 2a with a folding cover also shown in dotted lines;

FIG. 3 is an enlarged detailed view in the area of rear two conveyor carriers of FIG. 2B,

FIG. 4 is a schematic, perspective exploded view of a folding cover holding device configured as a folding cover cassette;

FIG. 5 is a schematic, perspective exploded view of a conveyor carrier together with the folding cover held in a folding cover cassette;

FIG. 6A is a side, enlarged detail view of the folding cover; and

FIG. 6b is an enlarged side view of detail Z shown in FIG. 6A.

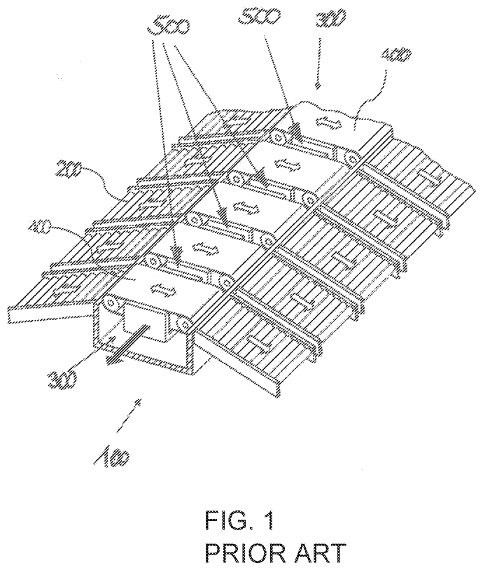

### DETAILED DESCRIPTION OF THE INVENTION

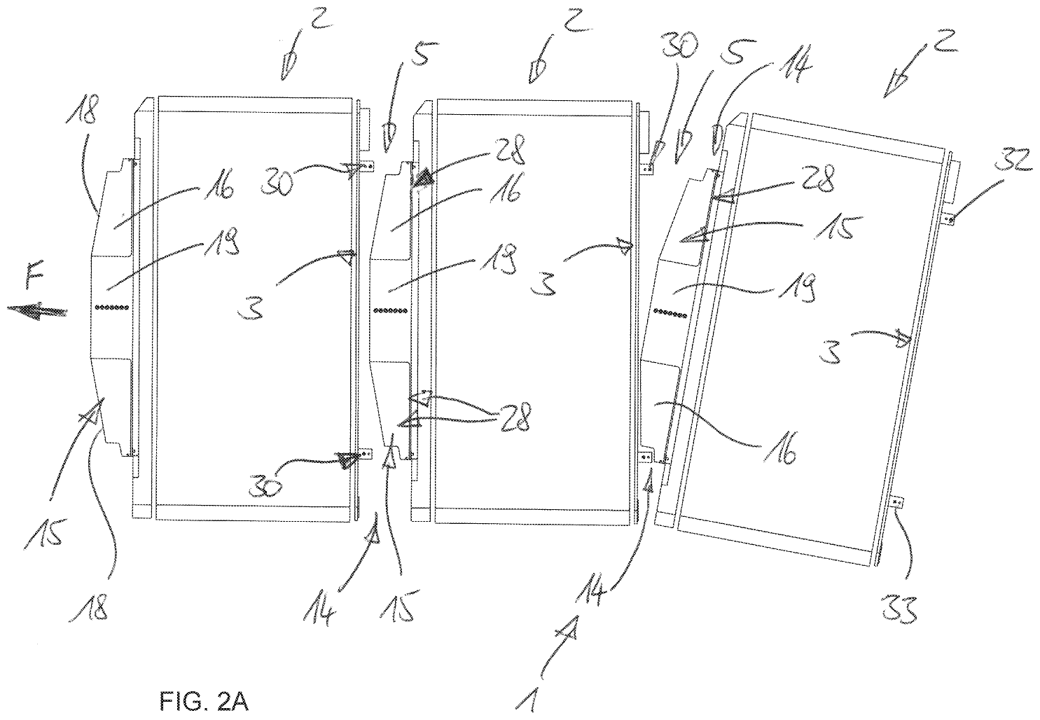

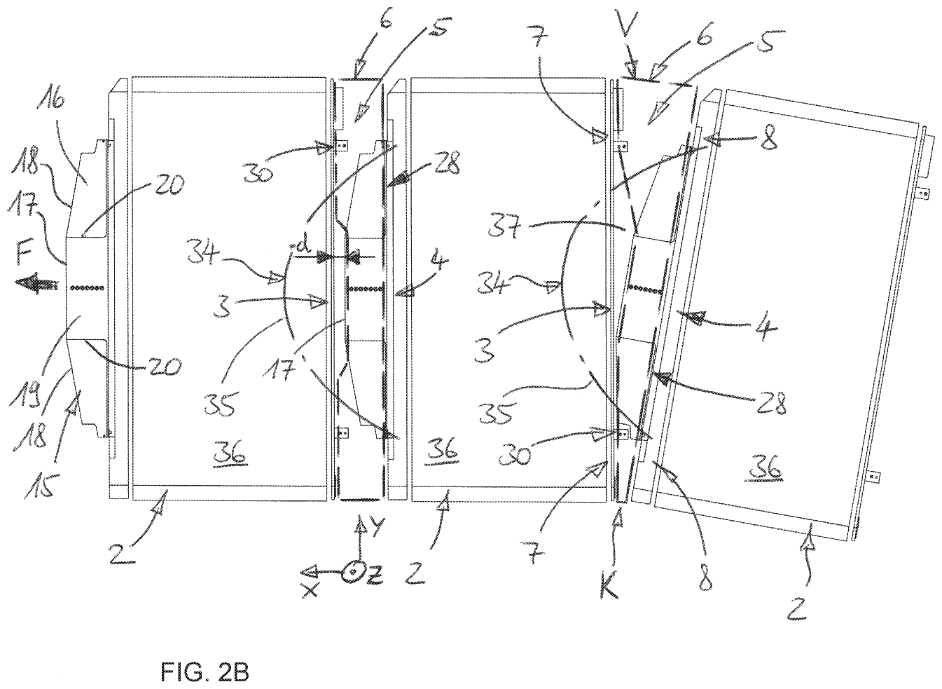

Referring now to the figures of the drawings in detail and first, particularly to FIG. 2A thereof, there is shown a top view of three conveyor carriers 2 of a sorting conveyor 1, which can have a plurality of further conveyor carriers 2, not shown here in total, moving on a conveyor belt and coupled to a conveyor carrier train, whereby a good not shown here can be transported in a resting manner on each of the conveyor carriers 2.

As can also be seen from FIG. 2A, a gap distance or gap 5 is formed between two directly successive conveyor carriers 2, in particular between a rear edge 3 of a front conveyor carrier 2 in the direction of travel F and a front edge 4 of a rear conveyor carrier 2 in the direction of travel F of the conveyor carrier train.

As can now be seen very clearly from FIG. 2B, a folding cover 6 is provided between each of the two immediately successive conveyor carriers 2 of the conveyor train, which is shown here only as a dashed line for reasons of clarity and which closes the gap 5, at least in certain areas, in relation to the longitudinal direction y of the gap and in relation to the transverse direction x of the gap. The folding cover 6 is suitable and designed, as will be explained in more detail below, to perform compensating movements between a rear edge zone 7 of the rear edge 3 of the front conveyor carrier 2 in the direction of travel F and an associated front edge zone 8 of the front edge of the rear conveyor carrier 2 in the direction of travel F in the event of travel-related relative distance changes, so that the gap 5 is essentially kept closed by means of the folding cover 6.

As can be seen very clearly from FIG. 2B, in the embodiment shown here, the folding cover 6 essentially completely closes the gap 5 between two immediately consecutive conveyor carriers 2, in relation to the longitudinal direction of the gap y and in relation to the transverse direction of the gap x, in every travel situation.

This ensures that no goods transported by the conveyor carrier 2 (not shown) can fall into the area of gap 5 between two conveyor carriers 2 and possibly cause them to derail.

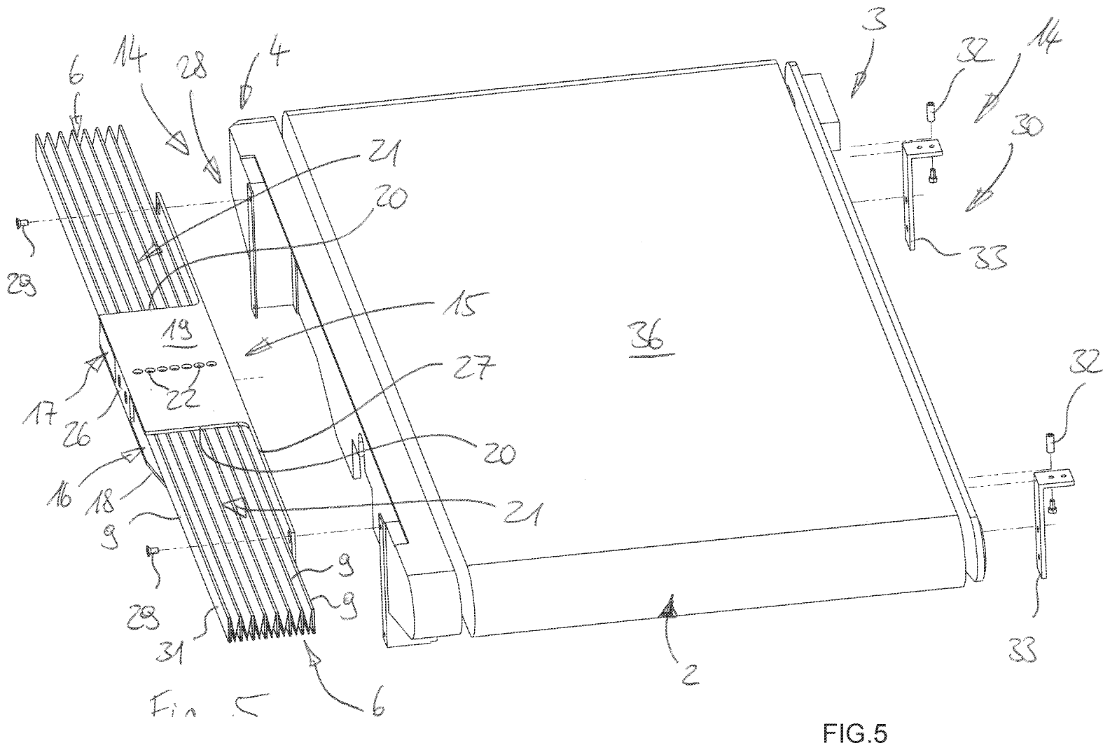

For this purpose, it is also particularly preferable if the folding cover 6, in relation to the vertical axis direction z, is arranged in an upper region of the conveyor carriers 2, i.e. essentially flush with the upper surface of the two conveyor carriers 2, as can be seen merely schematically and by way of example from the illustration in FIG. 5, which shows that the folding cover 6 is arranged essentially flush with the upper surface of the conveyor carrier 2 in the assembled state.

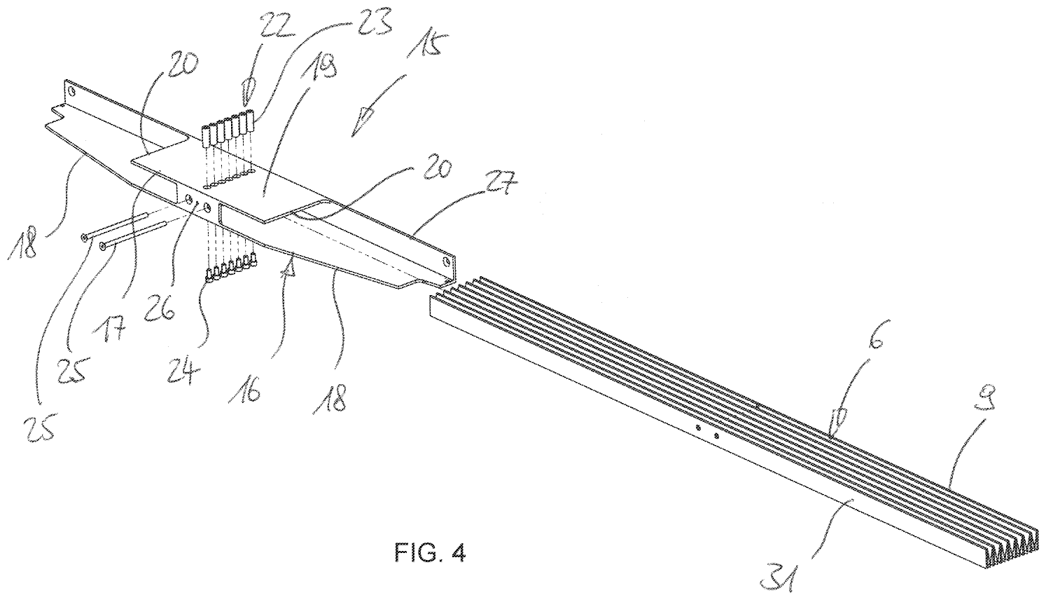

As can also be seen from FIG. 4, the folding cover 6 is formed here by a lamella folding cover folded in an accordion or zigzag manner with a plurality of individual lamellas 9, which unfolds to perform the compensating movements between the respective rear edge zones 7 of the front conveyor carriers 2 in the direction of travel F and the associated front edge zones 8 of the rear conveyor carriers 2 in the direction of travel F when the distance V is increased and folds up when the distance K is reduced.

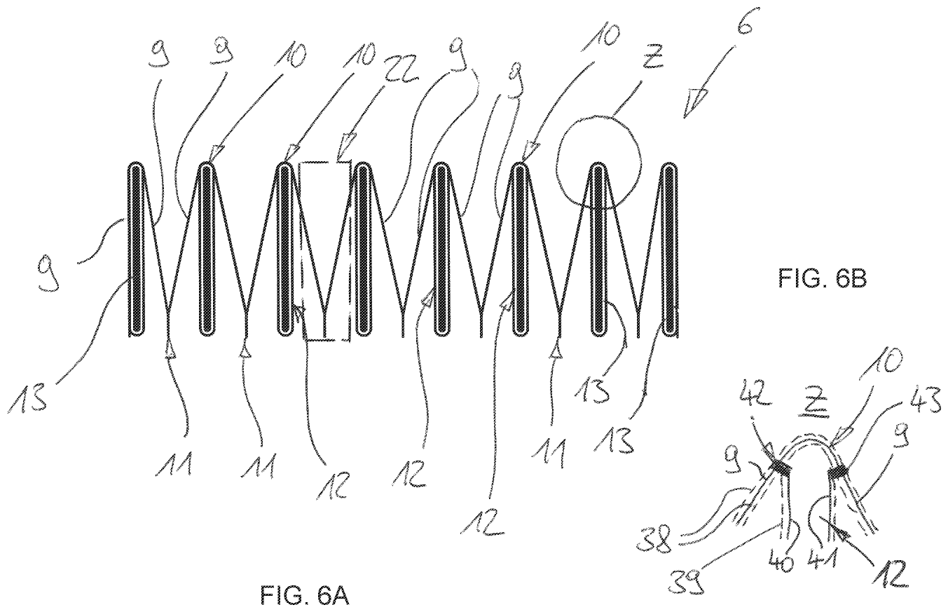

As can be seen in particular from FIG. 6A, the folding cover 6 is formed, for example, by a sheet of material folded in an accordion or zigzag manner, with the individual folding sections forming lamellas 9 running in the longitudinal direction of the folding cover, which alternately have upper connecting zones 10 and lower connecting zones 11. In the example shown here, the upper connecting zones 10 connect the lamellas 9 brought together there as a single piece of material, i.e. they are part of one and the same sheet of material. In contrast, the lamellas 9 in the example shown here are only connected to each other in an exemplary manner at the lower connecting zones 11, for example by welding, in particular high-frequency welding, so two sheet of materials are also connected to each other there. Of course, this is also possible the other way round, i.e. in one piece at the bottom and connected at the top. Both connecting zones 10, 11 can also be formed identically.

In the region of the upper connecting zones 10, the folding cover 6 has a pocket 12 projecting downwards in the vertical axis direction z, in which a strip-like stiffening element 13 is accommodated here by way of example only, the pocket 12 together with the stiffening element 13 also extending here by way of example essentially over the entire length of the folding cover 6.

The sheet of material of the lamellas 9 is formed here, as can be seen in particular from FIG. 6B, by a fabric coated on both sides, preferably with a water-repellent or waterproof material, it being preferably provided that the coating material or the double-sided coating 38 is formed by a thermoplastic polyurethane.

The pocket 12, on the other hand, is formed by a fabric coated only on the outside of the pocket and thus on one side, preferably with a water-repellent or waterproof material, it being preferably provided that the coating material or the one-sided coating 39 is formed by a thermoplastic polyurethane.

As can be seen in particular from FIG. 6B, the pocket 12 is welded in two connection areas 42, 43 with its coated outer side to a coated lamella 9 in each case, preferably welded by high-frequency welding. Specifically, for example, the pocket 12 is U-shaped and the free U-leg ends 40, 41 of the pocket 12 are welded with their coated outer sides to the correspondingly assigned coated lamellas 9, preferably welded at or near an upper connecting zone 10 of the folding cover 6, as shown in FIG. 6A.

The stiffening element 13 can be made of sheet metal or aluminum, for example.

A mounting device 14 is provided for arranging and fixing the folding cover 6 in the area of the gap 5, by means of which the folding cover 6 in the example shown here is fixed on the one hand to the rear edge 3 of the front conveyor carrier 2 in the direction of travel F and on the other hand to the front edge 4 of the rear conveyor carrier 2 in the direction of travel F.

For this purpose, the mounting device 14 has a folding cover holding device 15 configured as a folding cover cassette, by means of which the folding cover 6 can be supported from above and from below in relation to the vertical axis direction z, and by means of which the folding cover 6 can be fixed in the gap 5 in a precise position, here as an example and in a manner described in more detail below, in each case on the front edge 4 of the rear conveyor carrier 2 in the direction of travel F.

In the example shown here, the folding cover holding device 15, which is configured as a folding cover cassette, has a lower support element 16 in relation to the vertical axis direction z, which is formed here by a lower support plate, as can be seen very clearly from FIG. 4. The lower support element 16, configured as a support plate, thus extends below the folding cover 6 and supports it in a resting manner, which is particularly evident from FIG. 5.

As can also be seen from FIG. 5 in conjunction with FIG. 4, the lower support element 16 supports the folding cover 6 on its underside in such a way that it covers more than half of the longitudinal direction of the folding cover 6.

As can be seen in particular from FIGS. 2A and 2B, the lower support element 16 configured as a support plate is arranged in the basic state with the front edge 4 and rear edge 3 of two successive conveyor carriers 2 (the two conveyor carriers 2 on the left in the image plane of FIGS. 2A and 2B) aligned parallel to one another in such a way on the front edge 4 of the rear conveyor carrier 2 in the direction of travel, that a front support element edge 17 facing the rear edge 3 of the front conveyor carrier 2 in the direction of travel F has a gap distance d to a rear edge 3 of the front conveyor carrier 2 in the direction of travel F and, in the example shown here, is also aligned parallel to the rear edge 3 of the front conveyor carrier 2 in the direction of travel.

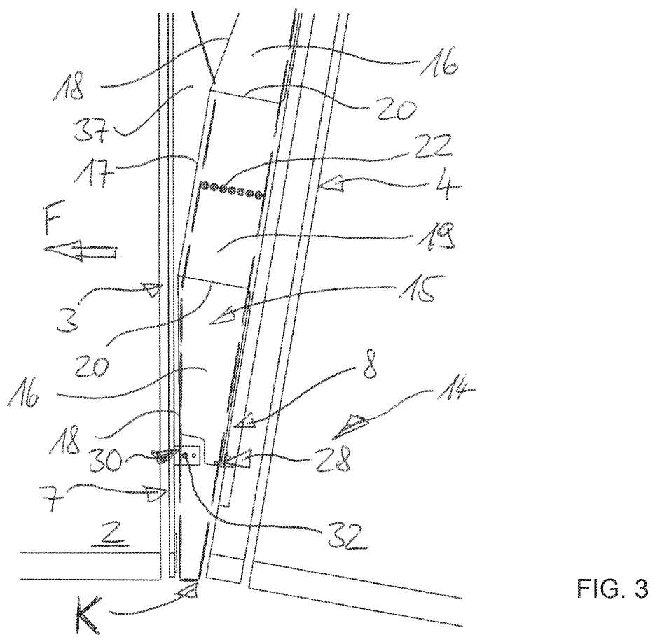

As can also be seen from FIGS. 3 and 4, the front support element edge 17, viewed in the longitudinal direction of the gap y, has a tapering 18 on both sides, which is formed here as a straight tapering 18. Starting from the front support element edge 17, the tapering 18 slopes backwards away from the front support element edge 17. These tapering elements 18 are provided here to enable a greater angular deflection between the two conveyor carriers 2 during cornering, as shown in FIGS. 2A, 2B and 3, compared to an imaginary continuously straight front support element edge 17, and, after a certain bending angle between the two conveyor carriers, to form a stop for the conveyor carrier 2 traveling in front of or behind it. FIGS. 2A and 2B show this in conjunction with the two rear conveyor carriers in relation to the image plane.

As can also be seen from the figures, the lower support element 16, in relation to the gap length in the longitudinal direction of the gap y, is preferably arranged approximately in a central area of the gap 5 and the lower support element 16 extends over more than half of the gap length as seen in the longitudinal direction of the gap y.

As can be seen in particular from FIGS. 4 and 5, the folding cover holding device 15 for forming a folding cover cassette also has an upper support element 19 with respect to the vertical axis direction z, which is again exemplarily formed here by an upper support plate. In the assembled state of the folding cover 6, this upper support element 19 extends above the folding cover 6, as can be seen in particular from FIG. 5, and covers the folding cover 6 on its upper side in a central folding cover area in relation to the longitudinal direction of the folding cover, so that the opposite support element side edges 20 of the upper support element 19 in the longitudinal direction of the gap form an abutment element for the folding cover areas 21 projecting beyond the upper support element 19 on both sides in the longitudinal direction of the gap, thus preventing the folding cover 6 or the two projecting folding cover areas from being lifted off of the two protruding folding cover areas 21 in the vertical axis direction z completely or, if necessary, after a defined displacement path.

As can be seen further from the combined view of FIGS. 4 and 5 and also from FIG. 6A, a pivot pin 22 aligned in the vertical axis direction z is arranged in the spaces between two directly adjacent lamellas 9 of the folding cover 6, which in the example case shown here penetrates at least the lower connecting zone 11 of the folding cover 6. The pivot pin 22 serves to hold and stabilize the respective stiffening elements 13 in their position, in particular to secure them against twisting and/or tilting. In addition, they preferably form a pivot bearing about which the respectively associated lamellas 9 and stiffening elements 13 can be pivoted in the horizontal plane of the folding cover, preferably within predetermined limits, in particular in such a way that when one side of the folding cover 6 is unfolded, the other side of the folding cover 6, which is opposite in the longitudinal direction of the folding cover, is folded up.

As can be seen in particular from FIG. 4, the pivot pins 22 are formed, for example, by screw sleeves 23 inserted from the upper support element 19, into which screws 24 are screwed from the lower support element 16.

In addition, as can also be seen very clearly from FIG. 4, two fixing bolts 25 are provided here as an example, which penetrate the lamellas 9 as seen in the direction of travel or transverse direction and are held on two connecting webs lying opposite each other in the direction of travel, the connecting web 26 at the front in the direction of travel being the connecting web from which the fixing bolts 25 are inserted or screwed in, while the connecting web at the rear in the direction of travel in the direction of travel F, while the connecting web at the rear in the direction of travel F simultaneously forms in a dual function a fastening ledge 27 as a component of a first fastening device 28 of the mounting device 14, by means of which the folding cover holding device 15 configured as a folding cover cassette in the example case shown here (see FIG. 5) can be fixed to the front edge 4 of the rear conveyor carrier 2 in the direction of travel F by means of two fastening screws 29.

The mounting device 14 also has a further, second fastening device 30, which in the example shown here is designed as a coupling connection, on which an end-side lamella 31 of the lamellas 9 can be attached. For this purpose, in the example shown here, the second fastening device 30 designed as a coupling connection has two suspension pins 32 spaced apart from one another in the longitudinal direction y of the gap or folding cover and assigned to opposite folding cover end regions, which in the example shown here project upwards from the rear edge 3 of the respective front conveyor carrier 2 in the vertical axis direction z. This can be seen very clearly in FIG. 5, where it is also shown that the suspension pins 32 are mounted on L-shaped brackets 33, which are bolted to the rear edge 3 of the respective conveyor carrier 2, for example, preferably bolted to already existing bolting points. It is sufficient here to unfold the two opposing folding cover end sections accordingly and attach them to the suspension pins 32.

As can also be seen from FIG. 2B, although this is only shown schematically and with a dotted line, a cover 34 can also be provided above the folding cover 6, as seen in the vertical axis direction z, which partially covers the folding cover 6 and is designed here, for example, as a cover plate. This cover 34 is here again attached to the front edge 4 of the respective rear conveyor carrier 2, preferably in the area of its fastening ledge 27, and in the basic position, with the front edge 4 and rear edge 3 of two successive conveyor carriers 2 aligned parallel to each other, is guided with a cover plate projection 35 under a transverse belt 36 of the respective front conveyor carrier 2.

In the exemplary embodiment shown here, the cover 34 or, in particular, the cover plate projection 35 has a semi-circular shape which serves to reliably and reliably cover any remaining gap remnants 37 (see FIG. 2B) of the gap 5, such as may occur when cornering, for example. The folding cover 6 itself is in any case longer than the cover 34 when viewed in the longitudinal direction of the folding cover 6 or in the longitudinal direction of the gap.

In conjunction with the cover 34, it is also advantageous if the conveyor carriers 2 are each provided with a transverse belt 36 that runs endlessly around deflection rollers and can be driven transversely to the direction of travel of the conveyor carriers 2 to form a cross-belt sorter, as shown in particular in FIG. 5.

The following is a summary list of reference numerals and the corresponding structure used in the above description of the invention.

### LIST OF REFERENCE SYMBOLS

1 Sorting conveyor
2 Conveyor carrier
3 Rear edge
4 Front edge
5 Gap
6 Folding cover
7 Rear edge zone
8 Front edge zone
9 Lamella
10 upper connecting zones
11 lower connecting zones
12 Pocket
13 Stiffening element
14 Mounting device
15 Folding cover-holding device
16 Lower support element
17 Front support element edge
18 Tapering
19 Upper support element
20 Support element side edge
21 Overhanging folding cover areas
22 Pivot pin
23 Screw sleeves
24 Screws
25 Fixing bolt
26 Connecting web
27 Fastening ledge
28 First fastening device
29 Fastening screws
30 Second fastening device
31 end-side lamella
32 suspension pin
33 L-shaped bracket
34 Cover
35 Cover plate projection
36 Crossbelt
37 Gap remnant
38 double-sided coating
39 One-sided coating
40 free U-leg end
41 free U-leg end
42 Connection area
43 Connection area
V Distance enlargement
K Distance reduction
F Direction of travel
d Gap distance
y Gap longitudinal direction
x Gap transverse direction
z Vertical axis direction

1. A sorting conveyor for transporting and sorting goods, the sorting conveyor comprising:
a conveyor track;
a plurality of conveyor carriers being moved on said conveyor track, are coupled to form a conveyor carrier train or are moveable individually, on said conveyor carriers the goods are transportable in a resting manner, with a gap being formed between two directly successive said conveyor carriers of said conveyor carrier train;
at least one compensating element for closing said gap between the said two immediately successive conveyor carriers, at least in certain areas, with respect to a longitudinal direction of said gap and/or a transverse direction of said gap, and said at least one compensating element is suitable and configured to perform compensating movements between a rear edge zone of a rear edge of a front conveyor carrier, of said conveyor carriers, in a direction of travel and an associated front edge zone of a front edge of a rear conveyor carrier, of said conveyor carriers, in the direction of travel in an event of travel-related relative distance changes, in order to keep said gap substantially closed.

2. The sorting conveyor according to claim 1, wherein said at least one compensating element substantially completely closes said gap between said immediately successive conveyor carriers, with respect to the longitudinal direction of said gap and/or the transverse direction of said gap.

3. The sorting conveyor according to claim 1, wherein said at least one compensating element, relative to a vertical axis direction, is disposed in an upper-side region of said conveyor carriers.

4. The sorting conveyor according to claim 1, wherein said at least one compensating element is configured to keep said gap substantially closed by expansion of said at least one compensating element when the travel-related relative distance is increased and by contraction of said at least one compensating element when the travel-related relative distance is reduced.

5. The sorting conveyor according to claim 1, wherein said at least one compensating element is formed by a folding cover which unfolds to perform the compensating movements between said rear edge zone of said front conveyor carrier in the direction of travel and said associated front edge zone of said rear conveyor carrier in the direction of travel when the travel-related relative distance increases and folds up when the travel-related relative distance decreases.

6. The sorting conveyor according to claim 5, further comprising at least one mounting device, by means of said at least one mounting device said at least one compensating element is fastened, directly or indirectly to said rear edge of said front conveyor carrier in the direction of travel and directly or indirectly to said front edge of said rear conveyor carrier in the direction of travel.

7. The sorting conveyor according to claim 6, wherein said at least one mounting device has a folding cover holding device which accommodates at least a partial region of said folding cover and by means of which said folding cover, with respect to a vertical axis direction, is supportable from above and/or from below and/or by means of which said folding cover is fixable.

8. The sorting conveyor according to claim 7, wherein said folding cover holding device has a lower support element relative to the vertical axis direction, which extends below said folding cover and/or which covers and/or supports said folding cover on its underside over more than half of its longitudinal direction of extension.

9. The sorting conveyor according to claim 8, wherein said lower support element in a basic state, with said front edge and said rear edge of said two successive conveyor carriers aligned parallel to one another, is disposed on said first conveyor carrier of said two conveyor carriers such that a front support element edge facing said second conveyor carrier has a gap distance to said second conveyor carrier and/or is aligned substantially parallel to a correspondingly assigned said front edge or said rear edge of said second conveyor carrier.

10. The sorting conveyor according to claim 9, wherein said front support element edge, viewed in the longitudinal direction of said gap, has a tapering on both sides, starting from said front support element edge, slopes away from said front support element edge towards a rear.

11. The sorting conveyor according to claim 8, wherein said lower support element, relative to a gap length in the longitudinal direction of said gap, is disposed approximately in a central region of said gap and/or extends over more than half of the gap length in the longitudinal direction of said gap.

12. The sorting conveyor according to claim 7, wherein said folding cover holding device has an upper support element with respect to the vertical axis direction, which extends above said folding cover and/or covers said folding cover on its upper side.

13. The sorting conveyor according to claim 7, wherein said folding cover holding device has an upper support element and a lower support element, said folding cover is at least partially accommodated between said lower support element and said upper support element.

14. The sorting conveyor according to claim 13, wherein:
said folding cover holding device has at least one connecting web; and
said lower support element and said upper support element, for forming a folding cover cassette, are connected to one another by means of said at least one connecting web.

15. The sorting conveyor according to claim 14,
wherein said folding cover is a lamella folding cover folded in an accordion-like or zigzag-like manner with a plurality of lamellas; and
further comprising at least one fixing element penetrating said lamellas, as seen in the direction of travel or a transverse direction, and/or which is held on said at least one connecting web.

16. The sorting conveyor according to claim 7, wherein:
said at least one mounting device has at least one first fastening device, by means of said at least one first fastening device said folding cover holding device is fixable to said first conveyor carrier; and
said at least one mounting device has at least one further fastening device, by means of said at least one further fastening device said folding cover itself is fastenable to said second conveyor carrier.

17. The sorting conveyor according to claim 16, further comprising a plurality of screw connections, wherein said at least one first fastening device is formed by at least one fastening ledge which is fixable to said first conveyor carrier by means of said plurality of screw connections spaced apart in the longitudinal direction of said gap.

18. The sorting conveyor according to claim 16, wherein said at least one further fastening device is configured as a coupling connection, on which said folding cover is coupable.

19. The sorting conveyor according to claim 5, wherein said folding cover is formed by a sheet of material folded in an accordion-like or zigzag-like manner.

20. The sorting conveyor according to claim 5, wherein said folding cover has at least one stiffening element stiffening said folding cover.

21. The sorting conveyor according to claim 20, wherein:
said folding cover has a pocket formed therein; and
said folding cover has at least one strip-shaped and/or rod-shaped stiffening element accommodated in said pocket, said pocket and/or said at least one strip-shaped and/or rod-shaped stiffening element extending at least over a partial region of a length of said folding cover.

22. The sorting conveyor according to claim 19, wherein said sheet of material is formed by a fabric coated on both sides.

23. The sorting conveyor according to claim 21, wherein:
said folding cover is a lamella folding cover folded in an accordion-like or zigzag-like manner with a plurality of lamellas; and
said pocket is formed by a fabric coated only on an outer side of said pocket and thus on one side and said pocket is welded in at least one defined connection area with said coated outer side to at least one of said lamellas being a coated lamella.

24. The sorting conveyor according to claim 23, wherein:
at least some of said lamellas are coated lamellas; and
said pocket is U-shaped and free U-leg ends of said pocket are welded with said coated outer sides to correspondingly assigned, immediately adjacent said coated lamellas.

25. The sorting conveyor according to claim 20, wherein said at least one stiffening element is made of plastic, wood, iron, sheet metal or aluminum.

26. The sorting conveyor according to claim 20,
wherein said folding cover is a lamella folding cover folded in an accordion-like or zigzag-like manner with a plurality of lamellas; and
further comprising a pivot pin aligned in a vertical axis direction and disposed in an intermediate space between two directly neighboring said lamellas of said folding cover, said pivot pin penetrates a connecting zone of said folding cover, and/or said pivot pin is suitable and configured to hold an associated said at least one stiffening element in its position, and/or said pivot pin forms a pivot bearing about which a respectively associated said lamellae and/or said at least one stiffening element is pivotable in a horizontal plane of said folding cover.

27. The sorting conveyor according to claim 1,
further comprising deflection rollers; and
wherein said conveyor carriers, in order to form a cross-belt sorter, are each provided with a transverse belt which circulates endlessly around said deflection rollers and is drivable transversely to the direction of travel of said conveyor carriers.

28. A compensating element for use with conveyor carriers of a sorting conveyor, comprising:
the compensating element is configured to at least partially close a gap between two immediately successive said conveyor carriers, with respect to a longitudinal direction of the gap and/or a transverse direction of the gap; and
the compensating element is configured to perform compensating movements in an event of travel-related relative distance changes between a rear edge zone of a rear edge of a front conveyor carrier of the conveyor carriers in a direction of travel and an associated front edge zone of a front edge of a rear conveyor carrier of the conveyor carriers in the direction of travel, in order to keep the gap substantially closed.

29. A method for operating a sorting conveyor, the sorting conveyor having a plurality of conveyor carriers being moved on a conveyor track, are coupled to a conveyor carrier train or are movable individually, on which goods are transportable in a resting manner, with a gap being formed between two directly successive said conveyor carriers of the conveyor carrier train, which comprises the steps of:
providing at least one compensating element being configured to at least partially to close the gap between the two immediately successive conveyor carriers, with respect to a longitudinal direction of the gap and/or a transverse direction of the gap; and
configuring the at least one compensating element to perform compensating movements in an event of travel-related relative distance changes between a rear edge zone of a rear edge of a front conveyor carrier in a direction of travel and an associated front edge zone of a front edge of a rear conveyor carrier in the direction of travel, in order to keep the gap substantially closed.
